(19) United States
(12) Patent Application Publication
(10) Pub. No.: US 2015/0086678 A1
(43) Pub. Date: Mar. 26, 2015

(54) Caramel Treats Structure

(71) Applicant: Chin-Shih Chen, Taichung City (TW)

(72) Inventor: Chin-Shih Chen, Taichung City (TW)

(21) Appl. No.: 14/033,548

(22) Filed: Sep. 23, 2013

(51) Int. Cl. A23G 3/54; A23G 3/48

(52) U.S. Cl. CPC A23G 3/54; A23G 3/48; A23V 2002/00
USPC 426/92; 426/93; 426/94

(57) ABSTRACT

A caramel treats structure contains a body on which sticky ingredient is poured and crisp ingredient and crushed nuts are sprayed; wherein the sticky ingredient sticks the crisp ingredient and the crushed nuts on the body. Accordingly, the caramel treats structure contains the body with the sticky ingredient, the sticky ingredient, and the crushed nuts, thereby having various flavors.

### FIELD OF THE INVENTION

The present invent relates to a caramel treats structure which has various flavors.

### BACKGROUND OF THE INVENTION

Convention caramel treats structure is formed in a rectangle shape or a square shape. However, such a conventional caramel treats structure has simple and dull flavor.

The present invention has arisen to mitigate and/or obviate the afore-described disadvantages.

### SUMMARY OF THE INVENTION

The primary object of the present invention is to provide a caramel treats structure which has various flavors.

To obtain the above objective, a caramel treats structure provided by the present invention contains:

a body on which sticky ingredient is poured and crisp ingredient and crushed nuts are sprayed;

wherein the sticky ingredient sticks the crisp ingredient and the crushed nuts on the body.

Preferably, the body is formed in any one of a rectangle shape and a square shape.

Preferably, the body is made of flours, eggs, and baking powders.

Preferably, the sticky ingredient is chocolate sauce or maltose syrup.

Preferably, the crisp ingredient is any one of seaweed, vegetarian floss, and meat floss.

Preferably, the crushed nuts are any one of crushed almonds, crushed peanuts and crushed sesame seeds.

### BRIEF DESCRIPTION OF THE DRAWINGS

FIG. 1 is a cross-sectional perspective view showing the assembly of a part of a caramel treats structure according to a first embodiment of the present invention.

FIG. 2 is a cross sectional view showing the assembly of the caramel treats structure according to the first embodiment of the present invention.

FIG. 3 is a cross-sectional perspective view showing the assembly of a part of a caramel treats structure according to a second embodiment of the present invention.

### DETAILED DESCRIPTION OF THE PREFERRED EMBODIMENTS

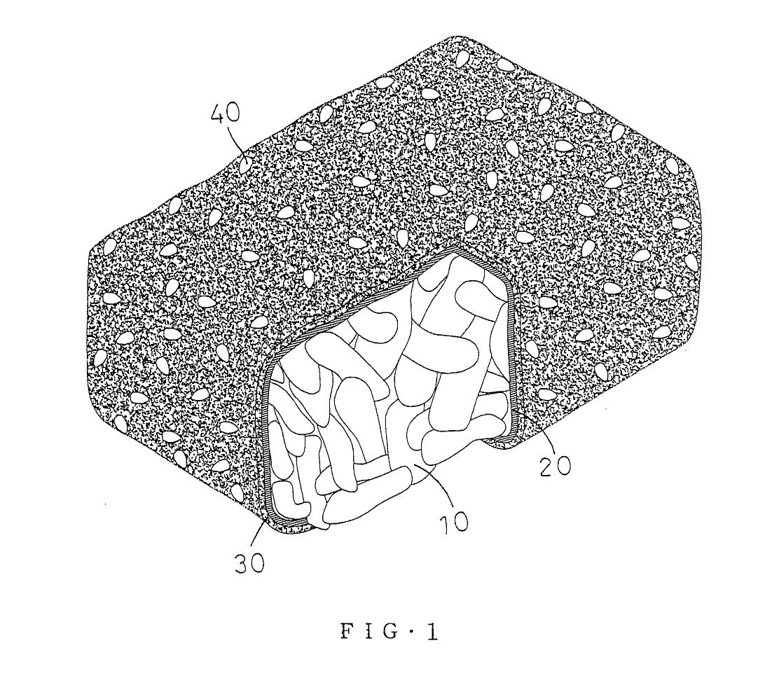

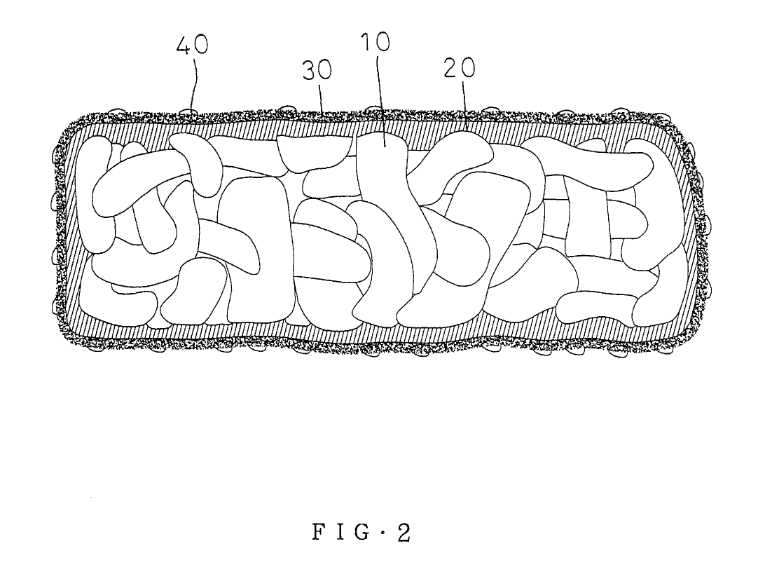

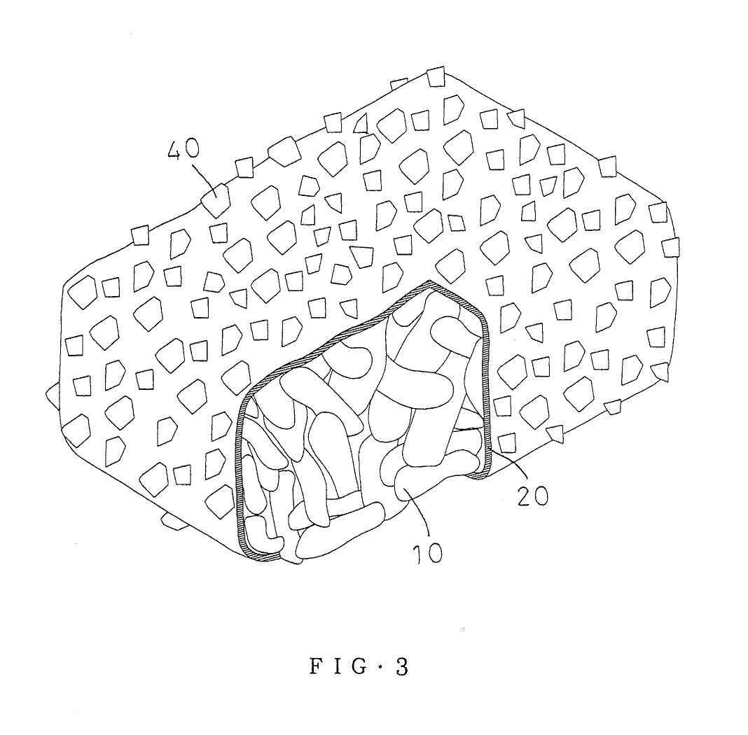

With reference to FIGS. 1-3, a caramel treats structure according to a first embodiment or a second embodiment of the present invention comprises: a body 10 formed in a rectangle shape or a square shape and made of flours, eggs, and baking powders, wherein the flour, the eggs, and the baking powder are mixed and then are kneaded into a dough, thereafter the dough is cut into a strip. The strip is then deep fried in an oil oven, taken out of the oil oven, added with syrup, putted in a food die, and cut into pieces. Thereafter, sticky ingredient 20, such as chocolate sauce or maltose syrup, is poured on the body 10. In addition, crisp ingredient 30 (such as seaweed, vegetarian floss or meat floss) and crushed nuts 40 (such as crushed almonds, crushed peanuts, or crushed sesame seeds) are sprayed on the body 10, such that the sticky ingredient 20 sticks the crisp ingredient 30 and the crushed nuts 40 on the body 10, thus producing caramel treats.

The caramel treats structure comprises the body 10 with the sticky ingredient 20, the sticky ingredient 30, and the crushed nuts 40, thereby having various flavors.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A caramel treats structure comprising:
a body on which sticky ingredient is poured and crisp ingredient and crushed nuts are sprayed;
wherein the sticky ingredient sticks the crisp ingredient and the crushed nuts on the body.

2. The caramel treats structure as claimed in claim 1, wherein the body is formed in a rectangle shape.

3. The caramel treats structure as claimed in claim 1, wherein the body is formed in a square shape.

4. The caramel treats structure as claimed in claim 1, wherein the body is made of flours, eggs, and baking powders.

5. The caramel treats structure as claimed in claim 1, wherein the sticky ingredient is chocolate sauce.

6. The caramel treats structure as claimed in claim 1, wherein the sticky ingredient is maltose syrup.

7. The caramel treats structure as claimed in claim 1, wherein the crisp ingredient is seaweed.

8. The caramel treats structure as claimed in claim 1, wherein the crisp ingredient is vegetarian floss.

9. The caramel treats structure as claimed in claim 1, wherein the crisp ingredient is meat floss.

10. The caramel treats structure as claimed in claim 1, wherein the crushed nuts are crushed almonds.

11. The caramel treats structure as claimed in claim 1, wherein the crushed nuts are crushed peanuts.

12. The caramel treats structure as claimed in claim 1, wherein the crushed nuts are crushed sesame seeds.
